(19) United States
(12) Patent Application Publication
(10) Pub. No.: US 2009/0129727 A1
(43) Pub. Date: May 21, 2009

(54) METHOD OF MANUFACTURING OPTICAL MODULE AND METHOD OF MANUFACTURING OPTICAL TRANSCEIVER

(75) Inventors: Junichi Shimizu, Kanagawa (JP); Kazuhiro Mitamura, Kanagawa (JP)

Correspondence Address: YOUNG & THOMPSON, 209 Madison Street, Suite 500, ALEXANDRIA, VA, 22314, US

(73) Assignee: NEC ELECTRONICS CORPORATION, Kanagawa (JP)

(21) Appl. No.: 12/258,769

(22) Filed: Oct. 27, 2008

(30) Foreign Application Priority Data
Nov. 15, 2007 (JP) 2007-296968

(51) Int. Cl. G02B 6/42

(52) U.S. Cl. 385/31

(57) ABSTRACT

A method of manufacturing an optical module according to an aspect of the present invention includes: preparing a stem including a first lead and a second lead to transmit an electrical signal from a photonic device, the second lead being shorter than the first lead; preparing a member having a first hole and a second hole which are formed therein so as to correspond to the first lead and the second lead, respectively; inserting the first lead into the first hole; and inserting the second lead into the second hole after inserting the first lead into the first hole.

### BACKGROUND

1. Field of the Invention

The present invention relates to a method of manufacturing an optical module and a method of manufacturing an optical transceiver.

2. Description of Related Art

In recent year, with the popularization of the Internet and Intranet and with an increase in capacity of communication data, optical communication networks have been developed. In particular, high-speed optical communications using optical fibers have rapidly penetrated the market not only as Fiber To The Home (FTTH) but also as Gigabit Ethernet® (GbE) and 10 Gigabit Ethernet (10GbE) in the data storage field.

In the optical fiber communications, optical transceivers are employed. For example, Small Form factor Pluggable (SFP) for 2.5 Gbps (Giga bits per second), and XENPAK, XFP, and the like for 10 Gbps are used as optical transceivers. In each of the optical transceivers, an optical receptacle module for insertion and removal of an optical connector plug is incorporated.

Examples of the optical receptacle module used for the optical transceivers include a Transmitter Optical Sub-Assembly (TOSA) incorporating a light emitting element, and a Receiver Optical Sub-Assembly (ROSA) incorporating a light receiving element. The TOSA may include a light emitting element provided in a CAN package, and the ROSA may include a light receiving element provided in a CAN package.

In the TOSA/ROSA using a CAN as a basic platform, leads extending from the CAN are usually inserted into a jig or the like to establish electrical conduction in a manufacturing/screening process. Further, in a process of mounting the TOSA/ROSA in an optical transceiver, the TOSA/ROSA is usually mounted such that the leads of the TOSA/ROSA, which extend from the CAN, are inserted into through-holes formed in a printed circuit board having a control IC and the like mounted thereon. Furthermore, the leads extending from the CAN are usually cut to adjust the lengths of the leads because the leads are directly fixed to the printed circuit board with solder.

Though automation is applied to a part of those processes, many processes are performed manually. As a result, there arises a problem of an increase in time required for the step of inserting the leads of the CAN into the holes of the jig and for the step of cutting the leads. Further, there arises another problem in that the CAN is damaged when the leads of the CAN are inserted into the holes of the jig by force.

Japanese Unexamined Patent Application Publication No. 61-158165 (Inoue et al.) discloses a lead shaping method in which leads of a CAN are inserted into holes, thereby shaping the leads. The technique disclosed in Inoue et al. is intended for shaping leads of a CAN, but the step of “passing leads through holes” is required.

Referring now to FIG. 7, a conventional method of manufacturing an optical module is described. FIG. 7 is a diagram for explaining the technique disclosed in Inoue et al. As shown in FIG. 7, a shaping block jig 20 has holes 24 formed therein so as to respectively correspond to a plurality of leads 1 formed for the CAN. An opening of each of the holes 24 has a diameter a little larger than the diameter of each of the leads 1 (hereinafter, referred to as “guiding” mechanism). The “guiding” mechanism is necessary because it is difficult to insert the plurality of leads, which have substantially the same length, into all the holes at the same time. Such a “guiding” mechanism facilitates the insertion of the leads into the holes 24.

In the technique disclosed in Inoue et al., the pitch between leads 1 is adjusted within an allowable value by using a retaining plate 11, and then the leads 1 are inserted into the shaping block jig 20, thereby correcting a local deformation.

Further, Japanese Unexamined Patent Application Publication No. 2003-329892 (Kuhara et al.) discloses a coaxial optical module having leads with different lengths.

### SUMMARY

The present inventors have found a problem that in the CAN serving as a basic platform of the TOSA/ROSA, the leads may be deformed during the manufacturing/screening process. In this case, as described above, even when the holes each having the tapered shape for “guiding” is formed in the jig, all the leads cannot be inserted into the holes smoothly, which may damage the CAN itself. Though it is possible to correct the deformation of the leads 1 in advance, the number of processes increases and the manufacturing/screening process is time consuming.

A first exemplary aspect of an embodiment of the present invention is a method of manufacturing an optical module, including: preparing a stem including a first lead and a second lead to transmit a signal from a photonic device, the second lead being shorter than the first lead; preparing a member having a first hole and a second hole formed therein so as to correspond to the first lead and the second lead, respectively; inserting the first lead into the first hole; and inserting the second lead into the second hole after inserting the first lead into the first hole.

A second exemplary aspect of an embodiment of the present invention is a method of manufacturing an optical transceiver, including: preparing an optical module including a stem having a first lead and a second lead to transmit a signal from a photonic device, the second lead being shorter than the first lead; preparing a printed circuit board having a first hole and a second hole formed therein so as to correspond to the first lead and the second lead, respectively; inserting the first lead into the first hole; and inserting the second lead into the second hole after inserting the first lead into the first hole.

In this manner, the leads are varied in length in advance so as to have at least two different lengths and the leads are “inserted into holes” in descending order of length, thereby facilitating “insertion of the leads into the holes” in order. As a result, the manufacturing time can be reduced without lowering the production yield.

According to the present invention, it is possible to realize a method of manufacturing an optical module and a method of manufacturing an optical transceiver that are capable of reducing the manufacturing time without lowering the production yield.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is a view showing the structure of a CAN according to an exemplary embodiment of the present invention;

FIG. 2 is a view showing the structure of a stem according to an exemplary embodiment of the present invention;

FIGS. 3A to 3H are manufacturing process cross-sectional views for explaining a method of manufacturing an optical module according to an exemplary embodiment of the present invention;

FIG. 4 is a diagram showing the structure of a jig used in a process of manufacturing an optical module;

FIG. 5 is a view showing the structure of an optical transceiver according to an exemplary embodiment of the present invention;

FIGS. 6A to 6D are manufacturing process cross-sectional views for explaining a method of manufacturing the optical transceiver according to an exemplary embodiment of the present invention; and

FIG. 7 is a diagram showing a conventional process of manufacturing an optical module.

### DESCRIPTION OF THE PREFERRED EMBODIMENTS

### First Exemplary Embodiment

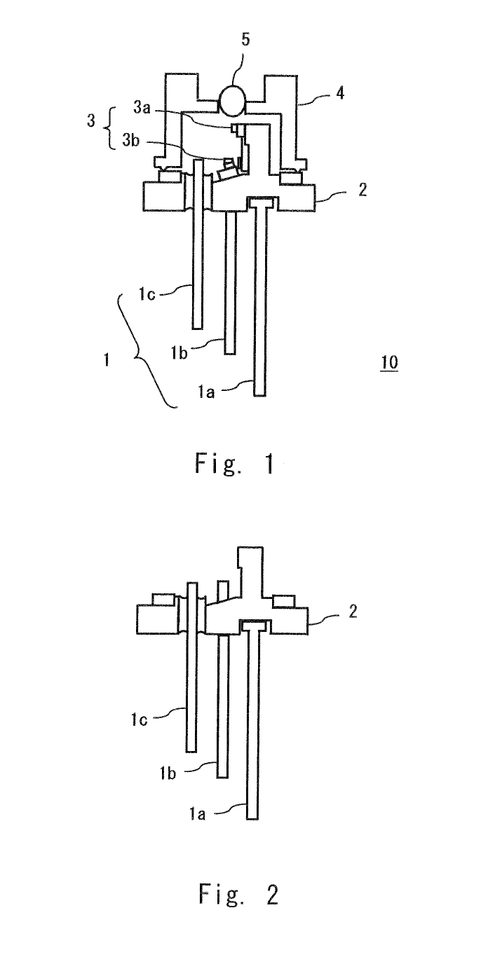

Referring to FIGS. 1 and 2, a description is given of the structure of a CAN used for an optical transmitter/receiver module (hereinafter, referred to as “optical module”) according to an exemplary embodiment of the present invention. FIG. 1 is a view showing the structure of a CAN 10 according to an exemplary embodiment of the invention. FIG. 2 is a view showing the structure of a stem 2 used for the CAN 10 according to an exemplary embodiment of the invention.

Note that the CAN 10 according to an exemplary embodiment of the invention is an electric component used for mutually converting an electrical signal and an optical signal. TOSA/ROSA includes the CAN 10 and an optical receptacle. The TOSA includes a laser diode (LD) serving as a light emitting element that generates an optical signal. The ROSA includes a photodiode (PD) serving as a light receiving element that detects the optical signal. In this case, the CAN 10 is described as an example. The CAN 10 includes a light emitting element 3a and a light receiving element 3b for monitoring light intensity of the light emitting element, which serve as a photonic device 3. Further, the CAN 10 has an optical transmission function.

Referring to FIG. 1, the CAN 10 according to an exemplary embodiment of the invention includes a plurality of leads 1, the stem 2, the photonic device 3, a cap 4, and a lens 5. The leads 1 each transmit a signal for driving and controlling the light emitting element 3a, or a signal received from the light receiving element 3b. In other words, the leads 1 each fulfill a function of receiving an electrical signal from the outside of the CAN 10 to transmit a signal for driving the TOSA, or a function of converting the light intensity of the light emitting element 3a provided inside the TOSA into an electrical signal to output the electrical signal to the outside of the CAN 10.

On the top surface of the stem 2, the photonic device 3 is mounted. The stem 2 has holes each penetrating from the bottom surface to the top surface. The leads 1 are each connected to the photonic device 3, which is mounted on the top surface, via the holes formed in the stem 2. The cap 4 is disposed so as to be opposed to the top surface of the stem 2 on which the photonic device 3 is mounted. The cap 4 is provided with the lens 5 so as to be substantially opposed to the light receiving element 3b.

The CAN 10 according to the present invention includes the plurality of leads 1 having different lengths. The CAN 10 according to an exemplary embodiment of the invention is provided with the four leads 1. Among the leads 1, the longest lead is referred to as a first lead 1a, the second longest (medium-length) lead is referred to as a second lead 1b, and the shortest lead is referred to as a third lead 1c. Note that the lengths of the leads 1 may be varied after the light emitting element and the light receiving element are mounted. Alternatively, as shown in FIG. 2, the leads 1 may be processed such that the plurality of leads 1 are varied in length, before the photonic device 3 is mounted.

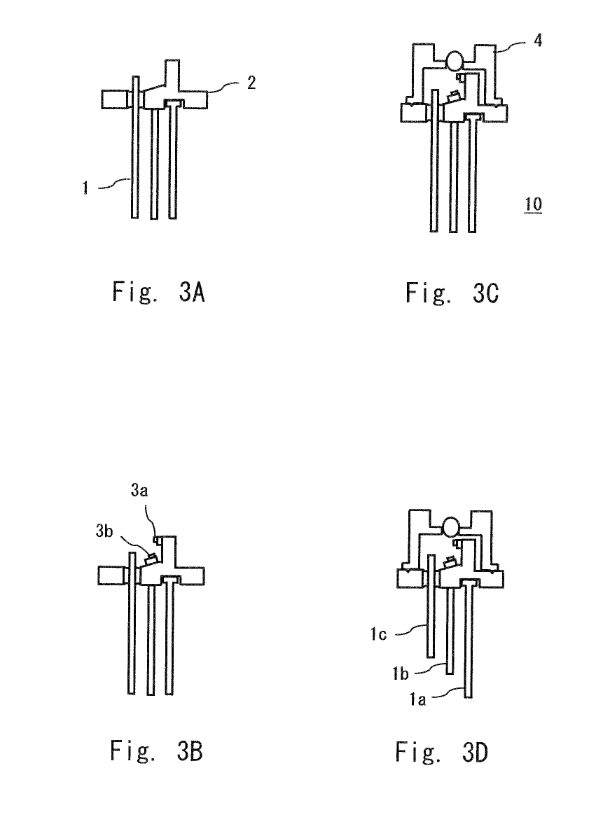

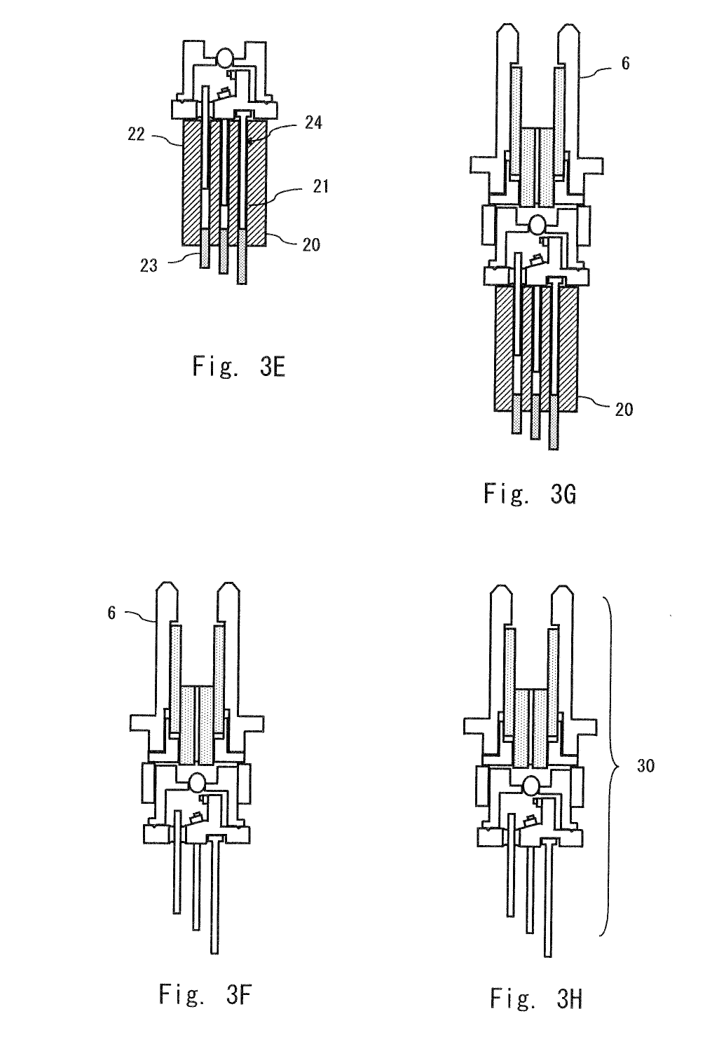

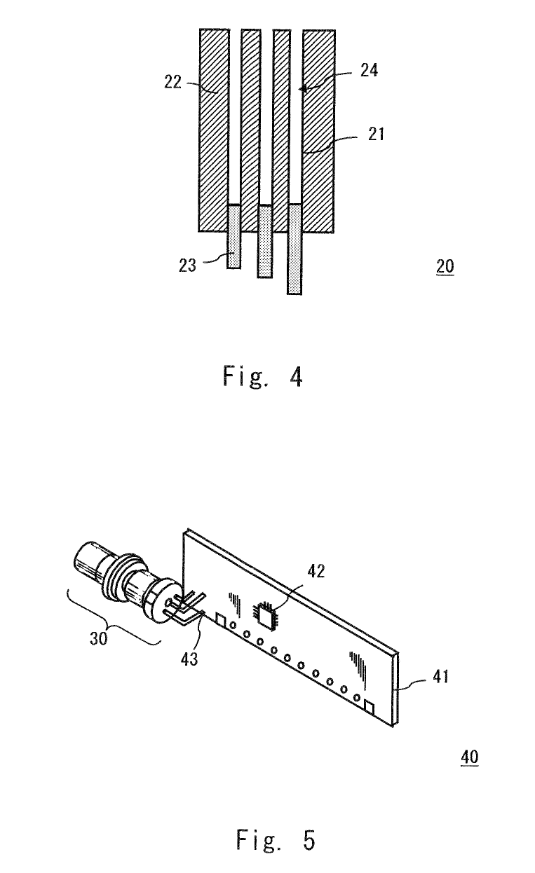

Referring now to FIGS. 3A to 3H, and FIG. 4, a description is given of a method of manufacturing an optical module according to an exemplary embodiment of the present invention. FIGS. 3A to 3H are views for explaining the method of manufacturing the optical module according to an exemplary embodiment of the invention. FIG. 4 is a diagram showing the structure of a jig 20 used for manufacturing the optical module.

Referring first to FIG. 3A, the stem 2 with the four leads 1 having substantially the same length is prepared. After that, as shown in FIG. 3B, the light emitting element 3a and the light receiving element 3b, which serve as the photonic device 3, are mounted on the top surface of the stem 2. Then, as shown in FIG. 3C, the cap 4 having the lens 5 is fixed to the stem 2, and the photonic device 3 is sealed in the space formed between the stem 2 and the cap 4. The CAN 10 is thus completed.

After that, as shown in FIG. 3D, the leads 1 extending from the CAN 10 are cut so as to obtain the first lead 1a, the second lead 1b, and the third lead 1c which have different lengths. Then, as shown in FIG. 3E, the leads 1 having different lengths are inserted into the jig 20. Referring to FIG. 4, the jig 20 includes electric contact portions 21, insulating portions 22, electric lead portions 23, and holes 24. The leads 1 are respectively inserted into the holes 24 of the jig 20, thereby enabling characteristic screening of the CAN 10.

In this case, the leads 1 are inserted into the holes 24 of the jig 20 in descending order of length beginning with the longest lead 1. According to an exemplary embodiment of the invention, the first lead 1a, which is the longest lead, is inserted into the hole 24, and then the second lead 1b having the medium length is inserted into the hole 24. After that, the third lead 1c, which is the shortest lead, is inserted into the hole 24. The technique of “inserting the leads 1 into the holes” in descending order of length facilitates the “insertion of the leads into the holes” in order by using the inserted longest lead as a first guide. As a result, the time required for the step of “inserting the leads into the holes” can be reduced as compared with the conventional CAN that includes the leads having substantially the same length.

Further, the structure of the jig with holes each having the tapered shape for “guiding” as the conventional case is complicated, which increases costs. According to the present invention, however, the structure is simple since it is only necessary to vary the lengths of the leads 1, which leads to a reduction in costs. As a matter of course, in the present invention, it is possible to use the jig with holes each having the tapered shape for “guiding” as in the conventional case. In other words, the tapered shape is formed on the opening side of each of the holes of the jig so that the diameter of the opening of each of the holes is larger than the diameter of the lead. Then, the leads 1 are inserted into the holes each having the tapered shape. As a result, the time required for the step can be further reduced.

Referring to FIG. 3F, the CAN 10 obtained after the characteristic screening is joined to a receptacle 6. Then, as shown in FIG. 3G, the can 10 with the receptacle is inserted into the jig 20, and the characteristic screening of the optical module is carried out again. Also in this case, the leads 1 are inserted into the holes 24 of the jig 20 in descending order of length beginning with the longest lead 1 in the above-mentioned manner. As a result, the time required for the step of “inserting the leads into the holes” can be reduced. When the characteristic screening is finished, an optical module 30 is completed as shown in FIG. 3H.

Note that, when the stem 2 including the leads 1 having different lengths is prepared in advance, the step of cutting the leads 1 extending from the CAN 10 in the manner as shown in FIG. 3D can be omitted.

The table below shows experimental results of measurement of the time for inserting each of the “CAN including leads having the same length” according to the prior art and the “CAN including leads having different lengths” according to an exemplary embodiment of the invention into the same jig having holes for inserting the leads. This experiment is conducted using CANs each having four leads. In addition, 10 CANs according to the prior art and 10 CANs according to the present invention are prepared, and the measurement is carried out on each of the CANs in the same manner. Note that the unit of time is “second” in Table 1.

TABLE 1

| | The present | |
|---|---|---|
| Sample No. | invention | Prior Art |
| 1 | 6.9 | 5.0 |
| 2 | 5.1 | 5.8 |
| 3 | 8.3 | 8.6 |
| 4 | 4.5 | 26.4 |
| 5 | 11.9 | 4.0 |
| 6 | 5.7 | 4.8 |
| 7 | 5.6 | 5.2 |
| 8 | 5.0 | 5.3 |
| 9 | 5.5 | 5.6 |
| 10 | 5.2 | 13.8 |
| Total | 63.7 | 84.5 |

As apparent from Table 1, the time required for the step of “inserting the leads into the holes” according to the present invention is about ¾ of that of the CANs according to the prior art. Though this experiment is conducted using the CANs each having four leads, it is easily conceivable that a difference in time required for the step increases as the number of leads increases.

As described above, in the method of manufacturing the optical module according to the present invention, the leads are inserted into the holes in descending order of length beginning with the longest lead, which facilitates the insertion of the leads in descending order of length by using the longest lead as a guide. Particularly when the leads are severely deformed before the leads are inserted into the holes, it takes a considerable time to, for example, shape the leads of the CAN including the leads having the same length. Also in this case, however, by varying the lengths of the leads, the time for insertion of the leads can be reduced.

### Second Exemplary Embodiment

Referring to FIG. 5, a description is given of the structure of an optical transceiver according to another exemplary embodiment of the present invention. FIG. 5 is a view showing the structure of an optical transceiver 40 according to another exemplary embodiment of the invention. As shown in FIG. 5, the optical transceiver 40 according to another exemplary embodiment of the invention includes the optical module 30, which is described in an exemplary embodiment of the invention, a printed circuit board 41, and an IC 42. The optical module 30 includes the plurality of leads 1 having different lengths.

The plurality of leads 1 of the optical module 30 are each bent by 90 degrees. In this case, the lead 1 located on the innermost side in the bending direction is the shortest lead 1c, and the lengths of the leads 1a to 1c increase toward the outside. The printed circuit board 41 has through-holes 43 formed therein so as to respectively correspond to the leads 1. The leads 1 are respectively inserted into the through-holes 43 formed in the printed circuit board 41.

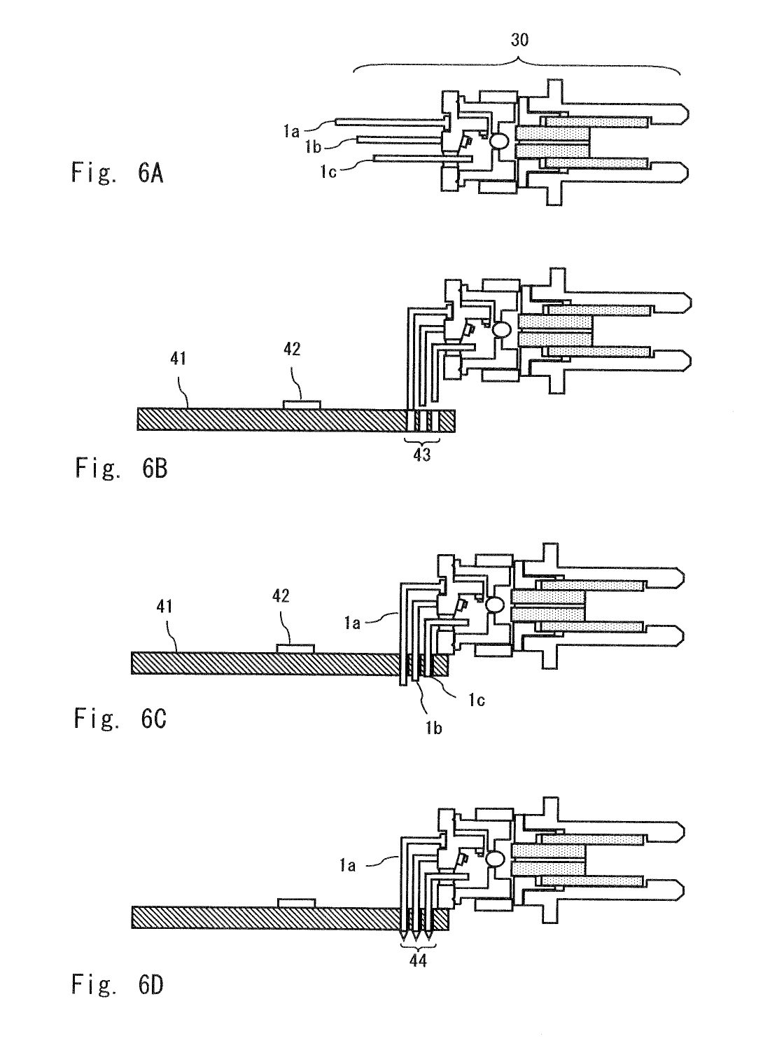

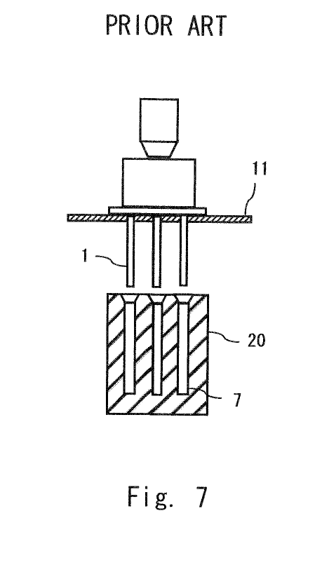

Referring now to FIGS. 6A to 6D, a method of manufacturing an optical transceiver according to another exemplary embodiment of the invention is described in comparison with the conventional method of manufacturing an optical transceiver. FIGS. 6A to 6D are manufacturing process cross-sectional views for explaining the method of manufacturing the optical transceiver according to another exemplary embodiment of the invention. Table 2 below shows comparison results between the method of manufacturing the optical transceiver according to the present invention and the method of manufacturing the optical transceiver according to the prior art.

TABLE 2

| Steps | The present invention | Prior Art |
|---|---|---|
| 1 | Prepare a printed circuit | Prepare a printed circuit |
| | board having a control IC | board having a control IC |
| | and the like mounted | and the like mounted |
| | thereon | thereon |
| | Prepare an optical module | Prepare an optical module |
| | including leads having | including leads having |
| | different lengths in | substantially the same |
| | advance | length |
| 2 | | Cut the leads into |
| | | desired length |
| | Bend the leads to a | Bend the leads to |
| | desired angle | desired angle |
| 3 | Insert the leads of the | Insert the leads of the |
| | optical module into | optical module into |
| | through-holes of the | through-holes of the |
| | printed circuit board | printed circuit board |
| 4 | Perform soldering | Perform soldering |
| 5 | Mount the print circuit | Mount the print circuit |
| | board having the optical | board having the optical |
| | module in the casing of | module in the casing of |
| | the optical transceiver | the optical transceiver |
| 6 | Perform characteristic | Perform characteristic |
| | screening of the optical | screening of the optical |
| | transceiver | transceiver |
| 7 | Complete the optical | Complete the optical |
| | transceiver | transceiver |

Referring first to FIG. 6A, the printed circuit board 41 having the control IC 42 and the like mounted thereon, and the optical module 30 including the leads 1 having different lengths are prepared (Step 1 in Table 2). Then, as shown in FIG. 6B, the leads 1 of the optical module 30 are bent by taking into consideration of the thickness of the printed circuit board 41, into which the leads 1 are inserted, and the pitch between the through-holes 43 (Step 2 in Table 2). On the other hand, in the conventional manufacturing method, it is necessary to cut the leads by adjusting the lengths of the leads in Step 2. According to the present invention, however, the use of the optical module 10, which includes the leads having different lengths and which is manufactured according to an exemplary embodiment of the invention, eliminates the necessity of the step of “cutting the leads by adjusting the lengths of the leads”.

After that, as shown in FIG. 6C, the leads 1 of the optical module 30 are respectively inserted into the through-holes 43 formed in the printed circuit board 41 (Step 3 in Table 2). In this case, the leads 1 are inserted into the through-holes 43 in descending order of length beginning with the longest lead 1. According to another exemplary embodiment of the invention, the longest first lead 1a is inserted first, and then the second lead 1b having the medium length is inserted into the hole. After that, the third lead 1c, which is the shortest lead, is inserted into the through-hole 43. The use of the technique of “inserting the leads 1 into the through-holes” in descending order of length facilitates the “insertion of leads into through-holes” in order by using the inserted longest lead as the first guide. As a result, the time required for the step of “inserting leads into through-holes” can be reduced as compared with the conventional case in which the leads have substantially the same length.

Then, as shown in FIG. 6D, the leads 1 are fixed to the printed circuit board 41 with a solder 44 (Step 4 in Table 2). After that, the printed circuit board with the optical module is mounted in the casing of the optical transceiver, and characteristic screening is carried out. Thus, the optical transceiver is completed.

As described above, according to the present invention, it is possible to reduce the time required for the step of “inserting leads of a CAN into holes” without lowering the production yield. As a result, a reduction in costs of an optical transmitter/receiver module can be achieved. Leads are inserted into holes in descending order of length by using a CAN or a stem including leads that are varied in length in advance according to the present invention, which facilitates the manufacturing process and reduces the rate at which the CAN is damaged when the leads are inserted into the holes by force as in the conventional case. Also in the method of assembling an optical transceiver, since the leads are varied in length in advance, the mounting operation can be easily performed and the step of cutting the leads immediately before the operation is eliminated.

The first and second exemplary embodiments can be combined as desirable by one of ordinary skill in the art.

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

What is claimed is:

1. A method of manufacturing an optical module, comprising:
preparing a stem including a first lead and a second lead to transmit a signal from a photonic device, the second lead being shorter than the first lead;
preparing a member having a first hole and a second hole formed therein so as to correspond to the first lead and the second lead, respectively;
inserting the first lead into the first hole; and
inserting the second lead into the second hole after inserting the first lead into the first hole.

2. The method of manufacturing an optical module according to claim 1, further comprising:
forming a tapered shape on an opening side of each of the first hole and the second hole; and
inserting the first lead and the second lead into the first hole second hole having the tapered shape, respectively, the first hole and the second hole each having the tapered shape.

3. A method of manufacturing an optical transceiver, comprising:
preparing an optical module including a stem having a first lead and a second lead to transmit a signal from a photonic device, the second lead being shorter than the first lead;
preparing a printed circuit board having a first hole and a second hole formed therein so as to correspond to the first lead and the second lead, respectively;
inserting the first lead into the first hole; and
inserting the second lead into the second hole after inserting the first lead into the first hole.

4. The method of manufacturing an optical transceiver according to claim 3, further comprising:
forming a tapered shape on an opening side of each of the first hole and the second hole; and
inserting the first lead and the second lead into the first hole and the second hole, respectively, the first hole and the second hole each having the tapered shape.
